(19) United States
(12) Patent Application Publication
(10) Pub. No.: US 2008/0171195 A1
(43) Pub. Date: Jul. 17, 2008

(54) Method For Applying Integrated Pre-Treatment Layers Containing Dicarboxylic Acid Olefin Copolymers To Metallic Surfaces

(75) Inventors: Alexander Gothlich, Mannheim (DE); Guido Vandermeulen, Ilvesheim (DE); Markus Hickl, Munster (DE); Michael Dornbusch, Munster (DE); Helmut Witteler, Wachenheim (DE); Monica Fernandez Gonzalez, Frankenthal (DE)

Correspondence Address: CONNOLLY BOVE LODGE & HUTZ, LLP, P O BOX 2207, WILMINGTON, DE, 19899, US

(73) Assignee: BASF Atiengesellschaft, Ludwigshafen (DE)

(21) Appl. No.: 11/814,995

(22) PCT Filed: Jan. 24, 2006
(86) PCT No.: PCT/EP06/50415

§ 371 Date: Jul. 27, 2007

(30) Foreign Application Priority Data
Jan. 28, 2005 (DE) 102005004292.9
Dec. 20, 2005 (DE) 102005061317.9

(51) Int. Cl. C08F 2/46; B32B 5/00

(52) U.S. Cl. 428/336; 427/487; 522/106

(57) ABSTRACT

The present invention relates to a process for applying integrated pretreatment layers having a thickness of 1 to 25 μm to metallic surfaces, particularly the surfaces of coil metals, by treatment with a composition comprising at least one binder, crosslinker, a finely divided inorganic filler, and a dicarboxylic acid-olefin copolymer. It also relates to shaped metallic articles provided with an integrated pretreatment layer of this kind, and to a formulation for implementing the process.

The present invention relates to a process for applying integrated pretreatment layers having a thickness of 1 to 25 μm to metallic surfaces, particularly the surfaces of coil metals, by treatment with a composition comprising at least one binder, crosslinker, a finely divided inorganic filler, and a dicarboxylic acid-olefin copolymer. It also relates to shaped metallic articles provided with an integrated pretreatment layer of this kind, and to a formulation for implementing the process.

For producing thin-walled metallic workpieces such as, for example, automobile parts, bodywork parts, instrument paneling, exterior architectural paneling, ceiling paneling or window profiles, suitable metal sheets are shaped by means of appropriate techniques such as punching, drilling, folding, profiling and/or deep drawing. Larger components, such as automobile bodies, for example, are assembled if appropriate by welding together from a number of individual parts. The raw material for this purpose normally comprises long metal strips which are produced by rolling of the metal and which for the purposes of storage and transportation are wound up to form what are called coils.

The metallic components referred to must in general be protected against corrosion. In the automotive segment in particular the requirements in terms of corrosion control are very high. Newer models of automobile are nowadays being warranted for up to 30 years against rust perforation. Modern automobile bodies are produced in multistage operations and have a multiplicity of different coating films.

Whereas in the past the corrosion control treatment was essentially carried out on the finished metallic workpiece—an automobile body assembled by welding, for example—in more recent times the corrosion control treatment has increasingly been performed on the coil metal itself, by means of coil coating.

Coil coating is the continuous coating of metal strips, or coils, with usually liquid coating materials. Metal coils with a thickness of 0.2 to 2 mm and a width of up to 2 m are transported at a speed of up to 200 m/min through a coil-coating line, and are coated in the process. For this purpose it is possible to use, for example, cold-rolled coils of soft steels or construction-grade steels, electrolytically galvanized thin sheet, hot-dip-galvanized steel coil, or coils of aluminum or aluminum alloys. Typical lines comprise a feed station, a coil store, a cleaning and pretreatment zone, a first coating station along with baking oven and downstream cooling zone, a second coating station with oven, laminating station, and cooling, and also a coil store and winder.

The coil-coating operation normally comprises the following process steps:

1. If necessary: cleaning of the metal coil to remove contamination accumulated during the storage of the metal coil, and to remove temporary corrosion control oils, by means of cleaning baths.

2. Application of a thin pretreatment layer (<1 μm) by a dipping or spraying method or by roller application. The purpose of this layer is to increase the corrosion resistance, and it serves to improve the adhesion of subsequent coating films on the metal surface. Known for this purpose are Cr(VI)-containing, Cr(III)-containing, and also chromate-free pretreatment baths.

3. Application of a primer by a roller application method. The dry layer thickness is typically about 5-8 μm. Solvent-based coating systems are generally used in this case.

4. Application of one or more topcoat layers by a roller application method. The dry layer thickness in this case is approximately 15-25 μm. Here again, solvent-based coating systems are generally employed.

The layer construction of a metal coil coated in this way, such as a coated steel coil, is depicted diagrammatically in FIG. 1. Applied on the metal (1) are a conventional pretreatment layer (2), a primer (3), and also one or else two or more different topcoats (4).

Metal coils coated in this way are used for example to produce casings for what are known as white goods (refrigerators, etc.), as facing panels for buildings or else in automaking.

The coating of the metal coils with the pretreatment layer (2) and a primer (3) is very laborious. Moreover, within the market, there is continually increasing demand for Cr(VI)-free systems for corrosion control. There has therefore been no lack of attempts to replace the separate application of a pretreatment layer (2) and of the organic priming material (3) by a single, integrated pretreatment layer (2′), which takes on the function of both layers. A layer structure of such a kind is shown by way of example and diagrammatically in FIG. 2. The production of a coated metal coil will be significantly simplified as a result of such a one-stage operation.

Müller et al. disclose in “Corrosion Science, 2000, 42, 577-584” and also in “Die Angewandte Makromolekulare Chemie 1994, 221, 177-185” the use of styrene-maleic acid copolymers as corrosion preventatives for zinc pigments and/or aluminum pigments.

EP-A 122 229, CA 990 060, JP 60-24384, and JP-A 2004-68065 disclose the use of copolymers of maleic acid and also various other monomers such as styrene, other olefins and/or other vinyl monomers as corrosion preventatives in aqueous systems.

EP-A 244 584 discloses the use of copolymers of modified maleic acid units and styrene, sulfonated styrene, alkyl vinyl ethers, C₂ to C₆ olefins and also (meth)acrylamide as an addition to cooling water. The modified maleic acid units have functional groups, attached via spacers, such as, for example,—OH, —OR, —PO₃H₂, —OPO₃H₂, —COOH or, preferably, —SO₃H.

EP-A 1 288 232 and EP-A 1 288 228 disclose copolymers of modified maleic acid units and other monomers such as, for example, acrylates, vinyl ethers or olefins, the modified maleic acid units having heterocyclic compounds attached via spacers. The documents disclose the use of polymers of this kind as corrosion preventatives in aqueous systems, such as cooling water circuits, for example, and also as an ingredient of coatings.

JP-A 2004-204243 and JP-A 2004-204244 disclose steel sheets of improved solderability, which are aftertreated first with tin, then with zinc and subsequently with an aqueous formulation, for the purpose of improving solderability. The aqueous formulation comprises 100 to 800 g/l water-based acrylate resin, 50 to 600 g/l water-soluble rosins, 10 to 100 g/l of a corrosion preventative and also 1 to 100 g/l of antioxidants. In an alternative embodiment of the invention the formulation comprises 100-900 g/l of a water-based polyurethane resin, 10 to 100 g/l of a corrosion preventative and also 1 to 100 g/l of antioxidants. Corrosion preventatives which can be employed include amines and also styrene-maleic anhydride copolymers. Preference is given to using a polymer which comprises the ammonium salt of a maleic monoester as a polymer unit. The formulations comprise no crosslinkers and also no fillers or pigments. The layers are dried at 90° C. The thickness of the coating is 0.05 to 10 μm in each case.

JP-A 2004-218050 and also JP-2004-218051 disclose corresponding formulation and steel sheets coated therewith, the formulations here additionally comprising water-dispersible SiO₂.

JP-A 60-219 267 discloses a radiation-curable coating formulation which comprises 5% to 40% of a copolymer of styrene and also unsaturated dicarboxylic acids and/or their monoesters, 5% to 30% of phenolic resins, and 30% to 90% of monomeric acrylates. By means of the coating material it is possible to obtain rust preventative films which can be removed by alkali and have a thickness of 5 to 50 μm.

WO 99/29790 discloses compounds which comprise heterocycles having at least two secondary nitrogen atoms. The compounds can also be copolymers of modified maleic acid units and styrene or 1-octene, the modified maleic acid units having piperazine units attached via spacers. They are used to cure epoxy varnishes at temperatures below 40° C. The document mentions corrosion control coatings for construction-grade steel, having a thickness of 112 to 284 μm.

U.S. Pat. No. 6,090,894 discloses copolymers of maleic monoesters or diesters and α-olefin-carboxylic acids and also, if appropriate, further monomers and also discloses their further functionalization by reaction of COOH groups on the copolymer with epoxy compounds. The compounds can be used for preparing coating materials.

None of the documents cited, however, discloses a process for applying integrated corrosion control layers, and especially not a continuous process for applying integrated corrosion control layers to coil metals.

DE-A 199 23 084 discloses a chromium-free aqueous coating material for single-stage coating, which comprises at least hexafluoro anions of Ti(IV), Si(IV) and/or Zr(IV), a water-soluble or water-dispersible film-forming binder, and also an organophosphoric acid. The composition may optionally also comprise a pigment and also crosslinking agents.

WO 2005/078025 discloses integrated pretreatment layers and also a process for applying integrated pretreatment layers which comprise dithiophosphoric esters as corrosion preventatives. Our as yet unpublished application DE 102005006233.4 discloses a process for applying integrated pretreatment layers which comprise dithio-phosphinic acids as corrosion preventatives. The use of polymeric corrosion preventatives is not disclosed.

It is an object of the invention to provide an improved process for generating integrated pretreatment layers, and also improved integrated pretreatment layers themselves.

Found accordingly has been a process for applying integrated pretreatment layers to metallic surfaces that comprises at least the following steps:

(1) applying a crosslinkable preparation to the metallic surface, said preparation comprising at least
(A) 20% to 70% by weight of at least one thermally and/or photochemically crosslinkable binder system (A),
(B) 20% to 70% by weight of at least one inorganic finely divided filler having an average particle size of less than 10 μm,
(C) 0.25% to 40% by weight of at least one corrosion preventative, and
(D) optionally a solvent,
with the proviso that the percentages by weight are based on the sum of all components bar the solvent, and also

(2) thermally and/or photochemically crosslinking the applied layer,

wherein the corrosion preventative is at least one copolymer (C) synthesized from the following monomeric structural units:
(c1) 70 to 30 mol % of at least one monoethylenically unsaturated hydrocarbon (c1a) and/or of at least one monomer (c1b) selected from the group of monoethylenically unsaturated hydrocarbons (c1b′), modified with functional groups X¹, and vinyl ethers (c1b″),
(c2) 30 to 70 mol % of at least one monoethylenically unsaturated dicarboxylic acid having 4 to 8 C atoms and/or its anhydride (c2a) and/or derivatives (c2b) thereof,
   the derivatives (c2b) being esters of the dicarboxylic acid with alcohols of the general formula HO—R¹—X²ₙ (I) and/or amides or imides with ammonia and/or amines of the general formula HR²N—R¹—X²ₙ (II), and the abbreviations having the following definition:
   R¹: (n+1)-valent hydrocarbon group having 1 to 40 C atoms, in which nonadjacent C atoms may also be substituted by O and/or N;
   R²: H, C₁ to C₁₀ hydrocarbon group or —(R¹—X²ₙ)
   n: 1, 2 or 3; and
   X²: a functional group; and also
(c3) 0 to 10 mol % of other ethylenically unsaturated monomers, different from (c1) and (c2) but copolymerizable with (c1) and (c2),
   the amounts being based in each case on the total amount of all monomer units in the copolymer.

In one preferred embodiment of the process it is a continuous process for coating metal coils.

Additionally found has been a formulation suitable for performing the process.

### INDEX TO THE FIGURES

FIG. 1: section through a coated metal coil with prior-art two-stage pretreatment.

FIG. 2: section through coated metal coil with inventive integrated pretreatment.

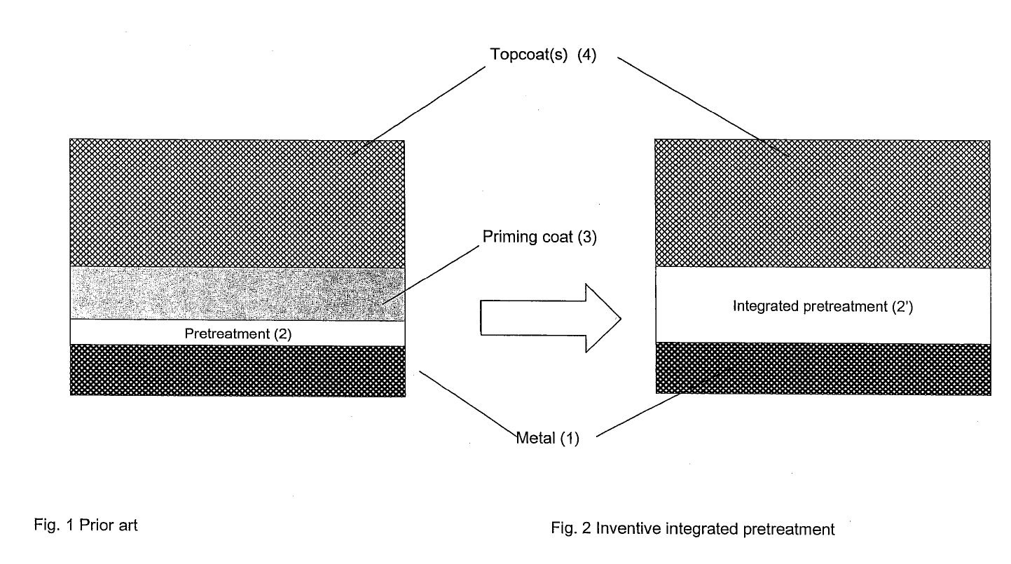

### DETAILS OF THE INVENTION NOW FOLLOW

By means of the process of the invention it is possible to provide metallic surfaces with an integrated pretreatment layer. The integrated pretreatment layers of the invention have a thickness of 1 to 25 μm.

The surfaces in question here may in principle be those of metallic articles of arbitrary shape. They may be the surfaces of articles composed entirely of metals; alternatively, the articles may be only coated with metals and may themselves be composed of other materials: polymers or composites, for example.

With particular advantage, however, the articles in question may be sheetlike shaped articles with a metallic surface, i.e., articles whose thickness is considerably less than their extent in the other dimensions. Examples include panels, foils, sheets, and, in particular, metal coils, and also metal-surfaced components manufactured from them—by parting, reshaping and joining, for example—such as automobile bodies or parts thereof, for example. The thickness, or wall thickness, of metallic materials of this kind is preferably less than 4 mm and for example 0.25 to 2 mm.

The process of the invention can be used in principle to coat all kinds of metals. The metals in question, however, are preferably base metals or alloys which are typically employed as metallic materials of construction and require protection from corrosion.

The process of the invention can be employed with preference in order to apply integrated pretreatment layers to the surfaces of iron, steel, zinc, zinc alloys, aluminum or aluminum alloys. The surfaces in question may in particular be those of galvanized iron or steel. In one preferred embodiment of the process the surface in question is that of a coil metal, particularly of electrolytically galvanized or hot-dip-galvanized steel. A steel coil in this context may be galvanized on one side or both sides.

Zinc alloys or aluminum alloys and their use for the coating of steel are known to the skilled worker. The skilled worker selects the nature and amount of alloying constituents in accordance with the desired end application. Typical constituents of zinc alloys comprise in particular Al, Pb, Si, Mg, Sn, Cu or Cd. Typical constituents of aluminum alloys comprise in particular Mg, Mn, Si, Zn, Cr, Zr, Cu or Ti. The term “zinc alloy” is also intended to include Al/Zn alloys in which Al and Zn are present in approximately equal amount. Steel coated with alloys of this kind is available commercially. The steel itself may comprise the typical alloying components known to the skilled worker.

The term “integrated pretreatment layer” for the purposes of this invention means that the coating of the invention is applied directly to the metal surface without any corrosion-inhibiting pretreatment such as passivating, application of a conversion coat or phosphating, and in particular no treatment with Cr(VI) compounds, being performed beforehand. The integrated pretreatment layer combines the passivating layer with the organic priming coat and also, if appropriate, further coats in a single layer. The term “metal surface” is of course not to be equated here with absolutely bare metal, but instead denotes the surface which inevitably forms when metal is typically employed in an atmospheric environment or else when the metal is cleaned prior to the application of the integrated pretreatment layer. The actual metal, for example, may carry a moisture film or a thin skin of oxide or of oxide hydrate.

Atop the integrated pretreatment layer it is possible with advantage for further coating films to be applied directly, without the need for an additional organic primer to be applied beforehand. It will be appreciated, however, that an additional organic primer is possible in special cases, though preferably is absent. The nature of further coating films is guided by the use envisioned for the metal.

The preparations used in accordance with the invention for the application of integrated pretreatment layers may be preparations based on organic solvents, aqueous or predominantly aqueous preparations, or solvent-free preparations. The preparations comprise at least one thermally and/or photochemically crosslinkable binder system (A), at least one finely divided inorganic filler (B), and at least one corrosion preventative (C).

The term “crosslinkable binder system” hereinbelow identifies, in a way which is known in principle, those fractions of the formulation that are responsible for the formation of a film. In the course of thermal and/or photochemical curing they form a polymeric network. They comprise thermally and/or photochemically crosslinkable components. The crosslinkable components may be of low molecular mass, oligomeric or polymeric. They have in general at least two crosslinkable groups. Crosslinkable groups may be either reactive functional groups able to react with groups of their own kind (“with themselves”) or with complementary reactive functional groups. Various possible combinations are conceivable here, in a way which is known in principle. The binder system may comprise, for example, a polymeric binder which is not itself crosslinkable, and also one or more low molecular mass or oligomeric crosslinkers (V). Alternatively the polymeric binder itself may contain crosslinkable groups which are able to react with other crosslinkable groups on the polymer and/or on a crosslinker employed addtionally. With particular advantage it is also possible to use oligomers or prepolymers which contain crosslinkable groups and are crosslinked with one another using crosslinkers.

Thermally crosslinkable or thermosetting binder systems crosslink when the applied film is heated at temperatures above room temperature. Coating systems of this kind are also referred to by the skilled worker as “baking varnishes”. They contain crosslinkable groups which at room temperature do not react, or at least not at any substantial rate, but instead react only at high temperatures. Crosslinkable binder systems particularly suitable for the performance of the process of the invention are those which crosslink only at temperatures above 60° C., preferably 80° C., more preferably 100° C., and very preferably 120° C. With advantage it is possible to use those binder systems which crosslink at 100 to 250° C., preferably 120 to 220° C., and more preferably at 150 to 200° C.

The binder systems (A) may be the binder systems that are typical in the field of coil-coating materials. The layers applied using coil-coating materials are required to exhibit sufficient flexibility. Binder systems for coil-coating materials therefore preferably contain soft segments. Suitable binders and binder systems are known in principle to the skilled worker. It will be appreciated that mixtures of different polymers can also be employed, provided that the mixing does not produce any unwanted effects. Examples of suitable binders comprise (meth)acrylate (co)polymers, partly hydrolyzed polyvinyl esters, polyesters, alkyd resins, polylactones, polycarbonates, polyethers, epoxy resin-amine adducts, polyureas, polyamides, polyimides or polyurethanes. The skilled worker makes an appropriate selection in accordance with the desired end use of the coated metal.

For systems which cure thermally it is possible to perform the invention using, preferably, binder systems based on polyesters, epoxy resins, polyurethanes or acrylates.

Binders based on polyesters can be synthesized, in a way which is known in principle, from low molecular mass dicarboxylic acids and dialcohols and also, if appropriate, further monomers. Further monomers comprise, in particular, monomers having a branching action, examples being tricarboxylic acids or trialcohols. For coil coating it is common to use polyesters having a comparatively low molecular weight, preferably those with an Mₙ of 500 to 10,000 g/mol, preferably 1000 to 5000 g/mol, and more preferably 2000 to 4000 g/mol.

The hardness and flexibility of the films based on polyesters can be influenced in a way which is known in principle, through the selection of “hard” or “soft” monomers. Examples of “hard” dicarboxylic acids comprise aromatic dicarboxylic acids or their hydrogenated derivatives such as, for example, isophthalic acid, terephthalic acid, phthalic acid, hexahydrophthalic acid and derivatives thereof, especially their anhydrides or esters. Examples of “soft” dicarboxylic acids comprise in particular aliphatic 1,ω-dicarboxylic acids having at least 4 C atoms, such as adipic acid, azelaic acid, sebacic acid or dodecanedioic acid. Examples of “hard” dialcohols comprise ethylene glycol, 1,2-propanediol, neopentyl glycol or 1,4-cyclohexanedimethanol. Examples of “soft” dialcohols comprise diethylene glycol, triethylene glycol, aliphatic 1,ω-dialcohols having at least 4 C atoms, such as 1,4-butanediol, 1,6-hexanediol, 1-8-octanediols or 1,12-dodecanediol. Preferred polyesters for performing the invention comprise at least one “soft” monomer.

Polyesters for coatings are available commercially. Details of polyesters are given for example in “Paints and Coatings-Saturated Polyester Coatings” in Ullmann's Encyclopedia of Industrial Chemistry, 6th ed., 2000, Electronic Release.

Binder systems based on epoxides can be used for formulations having an organic or else an aqueous basis. Epoxy-functional polymers can be prepared, in a way which is known in principle, through the reaction of epoxy-functional monomers such as bisphenol A diglycidyl ether, bisphenol F diglycidyl ether or hexanediol diglycidyl ether with alcohols such as bisphenol A or bisphenol F, for example. Particularly suitable soft segments are polyoxyethylene and/or polyoxypropylene segments. These may be incorporated advantageously through the use of ethoxylated and/or propoxylated bisphenol A. The binders ought preferably to be chloride-free. Epoxy-functional polymers are available commercially, under the name Epon® or Epikote®, for example. Details of epoxy-functional polymers are given for example in “Epoxy Resins” in Ullmann's Encyclopedia of Industrial Chemistry, 6th. ed., 2000, Electronic Release

The epoxy-functional binders may additionally be further functionalized. Epoxy resin-amine adducts, for example, can be obtained by reacting the said epoxy-functional polymers with amines, especially secondary amines such as diethanolamine or N-methylbutanolamine, for example.

Polyacrylate-based binders are particularly suitable for water-based formulations. Examples of suitable acrylates comprise emulsion polymers or copolymers, especially anionically stabilized acrylate dispersions, obtainable in conventional manner from acrylic acid and/or acrylic acid derivatives, examples being acrylic esters such as methyl (meth)acrylate, ethyl (meth)acrylate, butyl (meth)acrylate or 2-ethylhexyl (meth)acrylate and/or vinylaromatic monomers such as styrene, and also, if appropriate, crosslinking monomers. The hardness of the binders may be adjusted by the skilled worker, in a way which is known in principle, through the proportion of “hard” monomers such as styrene or methyl methacrylate and “soft” monomers such as butyl acrylate or 2-ethylhexyl acrylate. Employed with particular preference for the preparation of acrylate dispersions are, furthermore, monomers which have functional groups that are able to react with crosslinkers. These may in particular be OH groups. OH groups can be incorporated into the polyacrylates through the use of monomers such as hydroxyethyl acrylate, hydroxypropyl acrylate, hydroxybutyl acrylate or N-methylolacrylamide, or else of epoxy acrylates followed by hydrolysis. Suitable polyacrylate dispersions are available commercially.

Binders based on polyurethane dispersions are particularly suitable for water-based formulations. Dispersions of polyurethanes can be obtained in a manner which is known in principle by stabilizing the dispersion by incorporating ionic and/or hydrophilic segments into the PU chain. As soft segments it is possible to use preferably 20 to 100 mol %, based on the amount of all diols, of relatively high molecular mass diols, preferably polyester diols, having an Mₙ of approximately 500 to 5000 g/mol, preferably 1000 to 3000 g/mol. With particular advantage it is possible to use, to perform the present invention, polyurethane dispersions which comprise bis(4-isocyanatocyclohexyl)methane as isocyanate component. Polyurethane dispersions of that kind are disclosed for example in DE-A 199 14 896. Suitable polyurethane dispersions are available commercially.

Suitable crosslinkers for the thermal crosslinking are known in principle to the skilled worker.

Suitable examples include epoxide-based crosslinkers in which two or more epoxy groups are joined to one another by means of a linking group. Examples comprise low molecular mass compounds having two epoxy groups such as hexanediol diglycidyl ether, phthalic acid diglycidyl ether or cycloaliphatic compounds such as 3,4-epoxycyclohexylmethyl 3′,4′-epoxycyclohexanecarboxylate.

Additionally suitable as crosslinkers are high-reactivity melamine derivatives, such as, for example, hexamethylolmelamine or corresponding etherified products such as hexamethoxymethylmelamine, hexabutoxymethylmelamine or else optionally modified amino resins. Crosslinkers of this kind are available commercially, as Luwipal® (BASF AG), for example.

Particular preference is given to using blocked polyisocyanate crosslinkers to perform the invention. On blocking, the isocyanate group is reacted reversibly with a blocking agent. On heating to higher temperatures, the blocking agent is eliminated again. Examples of suitable blocking agents are disclosed in DE-A 199 14 896, column 12 line 13 to column 13 line 2. Particular preference is given to using polyisocyanates blocked with ε-caprolactam.

In order to accelerate the crosslinking it is possible, in a way which is known in principle, to add suitable catalysts to the preparations.

The skilled worker makes an appropriate selection from among the crosslinkers in accordance with the binder employed and the outcome desired. It will be appreciated that mixtures of different crosslinkers can also be used, subject to the proviso that this does not adversely affect the properties of the layer. The amount of crosslinker can advantageously be 10% to 35% by weight in relation to the total amount of the binder.

The epoxy-functional polymers can be crosslinked using, for example, crosslinkers based on polyamines, such as diethylenetriamine, for example, amine adducts or polyamino amides. Advantage is possessed for example by crosslinkers based on carboxylic anhydrides or by the crosslinkers already mentioned that are based on melamine. Particular preference is also given to the blocked polyisocyanates already mentioned.

For the thermal crosslinking of the acrylate dispersions, for example, it is possible to employ the aforementioned crosslinkers based on melamine or blocked isocyanates. Epoxy-functional crosslinkers as well are suitable, furthermore.

For the thermal crosslinking of polyurethane dispersions or polyesters it is possible to make use for example of the aforementioned crosslinkers based on melamine, blocked isocyanates or epoxy-functional crosslinkers.

In the case of photochemically crosslinkable preparations the binder systems (A) comprise photochemically crosslinkable groups. The term “photochemical crosslinking” is intended to comprise crosslinking with all kinds of high-energy radiation, such as UV, VIS, NIR or electronic radiation (electron beams), for example. The groups in question may in principle be all kinds of photochemically crosslinkable groups, preference here being given, however, to ethylenically unsaturated groups.

Photochemically crosslinkable binder systems generally comprise oligomeric or polymeric compounds containing photochemically crosslinkable groups, and also, if appropriate, in addition, reactive diluents, generally monomers. Reactive diluents have a viscosity lower than that of the oligomeric or polymeric crosslinkers, and therefore adopt the part of a diluent in a radiation-curable system. For photochemical crosslinking such binder systems further comprise in general one or more photoinitiators.

Examples of photochemically crosslinkable binder systems comprise, for example, polyfunctional (meth)acrylates, urethane (meth)acrylates, polyester (meth)acrylates, epoxy (meth)acrylates, carbonate (meth)acrylates, polyether (meth)acrylates, in combination if appropriate with reactive diluents such as methyl (meth)acrylate, butanediol diacrylate, hexanediol diacrylate or trimethylolpropane triacrylate. More precise details on suitable radiation-curable binders are given in WO 2005/080484 page 3 line 10 to page 16 line 35. Suitable photoinitiators are found in the said specification at page 18 line 8 to page 19 line 10.

For the performance of the present invention it will be appreciated that it is also possible to use binder systems which can be cured by a combination of thermal and photochemical means (these systems also being known as dual-cure systems).

The preparation used in accordance with the invention comprises 20% to 70% by weight of the binder system (A). The quantity figures are based on the sum of all components of the preparation bar the solvent or solvent mixture. The quantity is preferably 30% to 60% by weight and more preferably 40% to 50% by weight.

The preparation used for the process of the invention further comprises at least one finely divided inorganic filler (B). The filler may also comprise an additional organic coating, for hydrophobicizing or hydrophilicizing, for example. The filler has an average particle size of less than 10 μm. The average particle size is preferably 10 nm to 9 μm and more preferably 100 nm to 5 μm. In the case of round or approximately round particles this figure refers to the diameter; in the case of particles of irregular shape, such as with needle-shaped particles, for example, it refers to the longest axis. By particle size is meant the primary particle size. The skilled worker is aware of course that finely divided solids frequently undergo agglomeration into larger particles, which for use must be dispersed intensively in the formulation. The particle size is chosen by the skilled worker in accordance with the desired properties of the layer. It is also guided, for example, by the desired layer thickness. As a general rule, the skilled worker will choose smaller particles for a low layer thickness.

Suitable fillers include, on the one hand, electrically conductive pigments and fillers. Additives of this kind serve to improve the weldability and to improve subsequent coating with electrocoat materials. Examples of suitable electrically conducting filers and pigments comprise phosphides, vanadium carbide, titanium nitride, molybdenum sulfide, graphite, carbon black or doped barium sulfate. Preference is given to using metal phosphides of Zn, Al, Si, Mn, Cr, Fe or Ni, especially iron phosphides. Examples of preferred metal phosphides comprise CrP, MnP, Fe₃P, Fe₂P, Ni₂P, NiP₂ or NiP₃.

It is also possible to use nonconducting pigments or fillers, such as finely divided amorphous silicas, aluminas or titanium oxides, for example, which may also have been doped with further elements. As an example it is possible to use amorphous silica modified with calcium ions.

Further examples of pigments comprise anticorrosion pigments such as zinc phosphate, zinc metaborate or barium metaborate monohydrate.

It will be appreciated that mixtures of different pigments can also be used. The pigments are employed in a quantity of 20% to 70% by weight. The precise quantity is determined by the skilled worker in accordance with the desired properties of the layer. When using conductivity pigments the quantities employed are typically greater than when using nonconducting fillers. Preferred quantities in the case of conductive pigments and fillers are 40% to 70% by weight; preferred quantities in the case of nonconductive pigments are 20% to 50% by weight.

Copolymer (C)

In accordance with the invention the composition further cornprises as corrosion preventative at least one copolymer (C). The copolymer is synthesized from the monomers (c1) and (c2) and also, optionally, (c3), it being possible of course in each case to employ two or more different monomers (c1), (c2) and/or, optionally, (c3). Other than (c1), (c2), and, if desired, (c3) there are no other monomers present.

Monomers (c1)

Monomers (c1) employed are 70 to 30 mol % of at least one monoethylenically unsaturated hydrocarbon (c1a) and/or of at least one monomer (c1b) selected from the group of monoethylenically unsaturated hydrocarbons c1b′, modified with functional groups X¹, and also monoethylenically unsaturated ethers (c1b″). The quantity figure is based on the total amount of all monomer units in the copolymer.

(c1a)

The monomers (c1a) may in principle be all hydrocarbons which contain an ethylenically unsaturated group. These may be straight-chain or branched aliphatic hydrocarbons (alkenes) and/or alicyclic hydrocarbons (cycloalkenes). They may also be hydrocarbons which besides the ethylenically unsaturated group contain aromatic radicals, especially vinylaromatic compounds. Preference is given to ethylenically unsaturated hydrocarbons in which the double bond is located in α position. As a general rule at least 80% of the monomers (c1a) employed ought to have the double bond in α position.

The term “hydrocarbons” is also intended to comprise oligomers of propene or of unbranched or, preferably, branched C₄ to C₁₀ olefins which have an ethylenically unsaturated group. Oligomers employed generally have a number-average molecular weight Mₙ of not more than 2300 g/mol. Preferably Mₙ is 300 to 1300 g/mol and more preferably 400 to 1200 g/mol. Preference is given to oligomers of isobutene, which may optionally further comprise additional C₃ to C₁₀ olefins as comonomers. Oligomers of this kind that are based on isobutene will be referred to below, following general usage, as “polyisobutene”. Polyisobutenes employed ought preferably to have an α-double bond content of at least 70%, more preferably at least 80%. Polyisobutenes of this kind—also referred to as reactive polyisobutenes—are known to the skilled worker and are available commercially.

Apart from the stated oligomers, suitable monomers (c1a) for performing the present invention include, in particular, monoethylenically unsaturated hydrocarbons having 6 to 30 C atoms. Examples of such hydrocarbons comprise hexene, heptene, octene, nonene, decene, undecene, dodecene, tetradecene, hexadecene, octadecene, eicosane, docosane, diisobutene, triisobutene or styrene.

Preference is given to using monoethylenically unsaturated hydrocarbons having 9 to 27, more preferably 12 to 24 C atoms and, for example, 18 to 24 C atoms. It will be appreciated that mixtures of different hydrocarbons can also be used. These may also be technical mixtures of different hydrocarbons, examples being technical C₂₀₋₂₄ mixtures.

As monomer (c1a) it is particularly preferred to use alkenes, preferably 1-alkenes having the aforementioned numbers of C atoms. The alkenes are preferably linear or at least substantially linear. “Substantially linear” is intended to denote that any side groups present are only methyl or ethyl groups, preferably only methyl groups.

Also particularly suitable are the stated oligomers, preferably polyisobutenes. Surprisingly it is possible by this means specifically to improve the processing properties in aqueous systems. The oligomers, however, are used preferably not as sole monomer but instead in a mixture with other monomers (c1a). It has been found appropriate not to exceed an oligomer content of 60 mol % in relation to the sum of all monomers (c1). If present, the amount of oligomers is in general 1 to 60 mol %, preferably 10 to 55, and more preferably 20 to 50 mol %, and, for example, about 20 mol %. Suitability for combination with polyisobutenes is possessed in particular by olefins having 12 to 24 C atoms.

(c1b′)

The monoethylenically unsaturated hydrocarbons (c1b′) modified with functional groups X¹ may in principle be all hydrocarbons which have an ethylenically unsaturated group and in which one or more H atoms of the hydrocarbon have been substituted by functional groups X¹.

These may be alkenes, cycloalkenes, or alkenes containing aromatic radicals. Preferably they are ethylenically unsaturated hydrocarbons in which the double bond is located in α position. In general the monomers (c1b′) have 3 to 30 C atoms, preferably 6 to 24 C atoms, and more preferably 8 to 18 C atoms. They preferably have one functional group X¹. The monomers (c1b′) are preferably linear or substantially linear α-unsaturated-ω-functionalized alkenes having 3 to 30, preferably 6 to 24, and more preferably 8 to 18 C atoms, and/or 4-substituted styrene.

With the functional groups X¹ it is possible with advantage to influence the solubility of the copolymer (C) in the formulation and also the anchoring to the metal surface and/or in the binder matrix. Depending on the nature of the binder system and of the metallic surface the skilled worker makes an appropriate selection of functional groups. The functional groups are preferably at least one selected from the group of —Si(OR³)₃ (with R³═C₁ to C₆ alkyl), —OR⁴, —SR⁴, —NR⁴₂, —NH(C═O)R⁴, COOR⁴, —(C═O)R⁴, —COCH₂COOR⁴, —(C═NR⁴)R⁴, —(C═N—NR⁴₂)R⁴, —(C═N—NR⁴—(C═O)—NR⁴₂)R⁴, —(C═N—OR⁴)R⁴, —O—(C═O)NR⁴, —NR⁴(C═O)NR⁴₂, —NR⁴(C═NR⁴)NR⁴, —CSNR⁴₂, —CN, —PO₂R⁴₂, —PO₃R⁴₂, —OPO₃R⁴₂, (with R⁴=independently at each occurrence H, C₁ to C₆ alkyl, aryl, alkali(ne earth) metal salt or —SO₃H.

With particular preference the groups X¹ are Si(OR³)₃ (with R³═C₁ to C₆ alkyl), —OR⁴, —NR⁴₂, —NH(C═O)R⁴, COOR⁴, —CSNR⁴₂, —CN, —PO₂R⁴₂, —PO₃R⁴₂, —OPO₃R⁴₂, (with R⁴=independently at each occurrence H, C₁ to C₆ alkyl, aryl, alkali(ne earth) metal salt or —SO₃H. Very particular preference is given to —COOH.

Examples of suitable monomers (c1b′) comprise C₄ to C₂₀ (α,ω)-ethenylcarboxylic acids, such as vinylacetic acid or 10-undecenecarboxylic acid, for example, C₂ to C₂₀ (α,ω)-ethenylphosphonic acids such as vinylphosphonic acid, for example, its monoester or diesters or salts, C₃ to C₂₀ ethenylcarbonitriles such as acrylonitrile, allylnitrile, 1-butenenitrile, 2-methyl-3-butenenitrile, 2-methyl-2-butenenitrile, 1-, 2-, 3- or 4-pentenenitrile or 1-hexenenitrile, or 4-substituted styrenes such as 4-hydroxystyrene or 4-carboxystyrene. It will be appreciated that mixtures of two or more different monomers (c1b′) can also be used. Preferably (c1b′) is 10-undecenecarboxylic acid.

(c1b″)

The vinyl ethers (c1b″) are, in a way which is known in principle, ethers of the general formula H₂C═CH—O—R⁶, in which R⁶ is a straight-chain, branched or cyclic, preferably aliphatic hydrocarbon group having 1 to 30 C atoms, preferably having 2 to 20 C atoms, and more preferably 6 to 18 C atoms. The vinyl ethers in question may also be modified vinyl ethers in which one or more H atoms in the group R⁶ have been substituted by functional groups X¹, where X¹ is as defined above. R⁶ is preferably a linear or substantially linear group, with functional groups X¹ present optionally being located preferably terminally. It will be appreciated that two or more different vinyl ethers (c1b″) may also be employed.

Examples of suitable monomers (c1b″) comprise 1,4-dimethylolcyclohexane monovinyl ether, ethylene glycol monovinyl ether, diethylene glycol monovinyl ether, hydroxybutyl vinyl ether, methyl vinyl ether, ethyl vinyl ether, butyl vinyl ether, cyclohexyl vinyl ether, dodecyl vinyl ether, octadecyl vinyl ether or tert-butyl vinyl ether.

To prepare the inventively used copolymers (C) it is possible to employ only the monomers (c1a) or only the monomers (c1b) or else a mixture of monomers (c1a) and (c1b). Preference is given to only monomers (c1a) or to a mixture of (c1a) and (c1b). In the case of a mixture of (c1a) and (c1b), preference is given to a mixture of (c1a) and (c1b′). In the case of a mixture the amount of monomers (c1b) is generally 0.1 to 60 mol % in relation to the sum of all monomers (c1), preferably 1 to 50 mol %, and more preferably 5 to 30 mol %.

Monomers (c2)

As monomers (c2) use is made in accordance with the invention of 30 to 70 mol % of at least one monoethylenically unsaturated dicarboxylic acid having 4 to 8 C atoms and/or anhydrides thereof (c2a) and/or derivatives thereof (c2b). The quantity figure refers to the total amount of all monomer units in the copolymer (C).

(c2a)

Examples of monoethylenically unsaturated dicarboxylic acids (c2a) comprise maleic acid, fumaric acid, citraconic acid, mesaconic acid, itaconic acid, methylenemalonic acid or 4-cyclohexene-1,2-dicarboxylic acid. The monomers may also be salts of the dicarboxylic acids and also—where possible—cyclic anhydrides thereof. A preferred monomer (c1a) is maleic acid and/or maleic anhydride.

(c2b)

The derivatives (c2b) of the monoethylenically unsaturated dicarboxylic acids are esters of the dicarboxylic acids with alcohols of the general formula HO—R¹—X²ₙ (I) and/or amides or imides with ammonia and/or amines of the general formula HR²N—R¹—X²ₙ (II). Preference is given in each case to 1,ω-functional alcohols and amines, respectively.

In these formulae X² is any functional group. With the functional groups X² as well it is possible with advantage to influence the solubility of the copolymer (C) in the formulation and also the anchoring to the metal surface and/or in the binder matrix. The skilled worker makes an appropriate selection of functional groups in accordance with the nature of the binder system and of the metallic surface. The groups in question may for example be acidic groups or groups derived from acidic groups. In particular the functional group may be one selected from the group of —Si(OR³)₃ (with R³═C₁ to C₆ alkyl), OR⁴, —SR⁴, —NR⁴₂, —NH(C═O)R⁴, COOR⁴, —(C═O)R⁴, —COCH₂COOR⁴, —(C═NR⁴)R⁴, —(C═N—NR⁴₂)R⁴, —(C═N—NR⁴—(C═O)—NR⁴₂)R⁴, —(C═N—OR⁴)R⁴, —O—(C═O)NR⁴, —NR⁴(C═O)NR⁴₂, —NR⁴(C═NR⁴)NR⁴, —CSNR⁴₂, —CN, —PO₂R⁴₂, —PO₃R⁴₂, —OPO₃R⁴₂, (with R⁴=independently at each occurrence H, C₁ to C₆ alkyl, aryl, alkali(ne earth) metal salt or —SO₃H. Preferably it is —SH, —CSNH₂, —CN, —PO₃H₂ or —Si(OR³)₃ and/or salts thereof, and very preferably —CN or —CSNH₂.

The number n of the functional groups X² in (I) or (II) is generally 1, 2 or 3, preferably 1 or 2, and more preferably (I).

In the formulae (I) and (II) R¹ is an (n+1)-valent hydrocarbon group having 1 to 40 G atoms which join the OH group and/or the NHR² group to the functional group or groups X². In the group it is possible for nonadjacent C atoms to be substituted by O and/or N. The group in question here is preferably a 1,ω-functional group.

In the case of divalent linking groups R¹ the groups in question are preferably linear 1,ω-alkylene radicals having 1 to 20, preferably 2 to 6 C atoms. Particular preference is given to 1,2-ethylene, 1,3-propylene, 1,4-butylene, 1,5-pentylene or 1,6-hexylene radicals. With further preference the groups in question may be groups which have O atoms, examples being —CH₂—CH₂—O—CH₂—CH₂— or polyalkoxy groups of the general formula —CH₂—CHR⁷—[—O—CH₂—CHR⁷—]ₘ—, where m is a natural number from 2 to 13 and R⁷ is H or methyl. Examples of compounds (I) and (II) with linking groups R¹ of this kind comprise HO—CH₂—CH₂—CSNH₂, HO—CH₂—CH₂—SH, H₂N—CH₂—CH₂—CH₂—Si(OCH₃)₃, H₂N—(—CH₂—)₆—CN, H₂N—CH₂—CH₂—OH or H₂N—CH₂—CH₂—O—CH₂—CH₂—OH.

If the radical is intended to bond two or more functional groups, it is possible in principle for two or more functional groups to be bonded to the terminal C atom. In this case, however, R¹ preferably has one or more branches. The branch may involve a C atom or, preferably, an N atom. Examples of compounds (II) having such a radical are (hydroxyethyl)aminobismethylenephosphonic acid (III) or (aminoethyl)aminobismethylenephosphonic acid (IIIa).

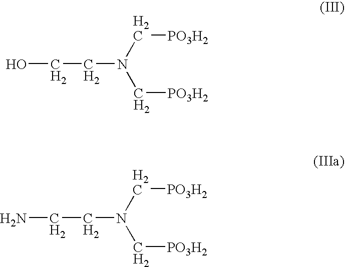

In the formulae (I) and (II) above, R² is H, a C₁ to C₁₀ hydrocarbon group, preferably a C₁ to C₆ alkyl group, or a group —R¹—X²ₙ, where R¹ and X²ₙ are as defined above. Preferably R² is H or methyl and with particular preference H.

The derivatives (c2b) of the dicarboxylic acids may in each case have both COOH groups of the dicarboxylic acid esterified or amidated with the compounds (I) and/or (II), respectively. Preferably, however, only one of the two COOH groups in each case is esterified or amidated. An imide may naturally be formed only with 2 COOH groups in common. These are preferably two adjacent COOH groups; of course, however, they may also be nonadjacent COOH groups.

Monomers (c3)

The copolymers (C) used in accordance with the invention may further comprise, as structural units, 0 to 10 mol %, preferably 0 to 5 mol %, more preferably 0 to 3 mol % of other ethylenically unsaturated monomers which are different from (c1) and (c2) but copolymerizable with (c1) and (c2). Monomers of this kind may be used—if necessary—to fine-tune the properties of the copolymer. With very particular preference no monomers (c3) are comprised.

Examples of monomers (c3) comprise, in particular, (meth)acrylic compounds such as (meth)acrylic acid or (meth)acrylic esters or hydrocarbons having conjugated double bonds such as butadiene or isoprene. The (meth)acrylic esters may also contain further functional groups, such as OH or COOH groups, for example. Additionally the monomers in question may also be monomers which have a crosslinking action, having two or more isolated ethylenically unsaturated double bonds. The copolymers ought not, however, to be too greatly crosslinked. If crosslinking monomers are present, their amount ought in general not to exceed 5 mol % with respect to the sum of all the monomers, preferably 3 mol % and more preferably 2 mol %.

The quantities of the monomers (c1), (c2), and (c3) to be used in accordance with the invention have already been given. The quantities of (c1) are preferably 35 to 65 mol % and those of (c2) 65 to 35 mol %; with particular preference (c1) is 40 to 60 mol % and (c2) is 60 to 40 mol %; and with very particular preference (c1) is 45 to 55 mol % and (c2) is 55 to 45 mol %. By way of example the quantity of (c1) and (c2) may in each case amount to approximately 50 mol %.

Preparation of the Copolymers (C)

The preparation of the copolymers (C) used in accordance with the invention is performed preferably by means of free-radical polymerization. The conduct of the free-radical polymerization, including required apparatus, is known in principle to the skilled worker. The polymerization is preferably carried out using thermally decomposing polymerization initiators. With preference it is possible to use peroxides as thermal initiators. The polymerization can of course also be performed photochemically.

As monomers (c2a) use is made preferably—where chemically possible—of the cyclic anhydrides of the dicarboxylic acids. Particular preference is given to using maleic anhydride.

Solvents which can be used include, preferably, aprotic solvents such as toluene, xylene, aliphatics, alkanes, benzine or ketones. Where long-chain monoethylenically unsaturated hydrocarbon monomers are employed which have a relatively high boiling point, especially those having a boiling point of more than about 150° C., it is also possible to operate without solvents. In that case the unsaturated hydrocarbons themselves act as solvents.

The free-radical polymerization with thermal initiators can be performed at 60-250° C., preferably 80-200° C., more preferably at 100-180° C., and in particular at 130 to 170° C. The quantity of initiator is 0.1% to 10% by weight relative to the quantity of the monomers, preferably 0.2% to 5% by weight, and with particular preference 0.5% to 2% by weight. Generally speaking a quantity of approximately 1% by weight is advisable. The polymerization time is typically 1-12 h, preferably 2-10 h, and very preferably 4-8 h. The copolymers can be isolated from the solvent by methods known to the skilled worker or alternatively are obtained directly in solvent-free form.

Where the copolymers are not reacted further to give the derivatives (c2b), anhydride groups present are generally hydrolyzed to form the corresponding dicarboxylic acid units. The procedure is guided in this case judiciously by the intended use of the copolymer.

Where the copolymer is to be used in an aqueous binder system, it is advisable to perform the hydrolysis in water. For this purpose the copolymer containing anhydride groups can be introduced into water and hydrolyzed, judiciously with gentle heating and with addition of a base. Temperatures of up to 100° C. have been found appropriate. Suitable bases include, in particular, tertiary amines such as dimethylethanolamine, for example. The amount of base is generally 0.1-2 equivalents (based on dicarboxylic anhydride units in the polymer), preferably 0.5 to 1.5 equivalents, and more preferably 0.7-1.2 equivalents. Typically the amount of base used is approximately one equivalent per anhydride group. The resulting aqueous solution or dispersion of the copolymer can be employed directly for preparing the crosslinkable preparation for the process. Of course, however, the copolymers can also be isolated by methods known in principle to the skilled worker.

If the copolymer is to be employed in a binder system based on organic solvents, it can be dissolved or dispersed in an organic solvent such as THF, dioxane or toluene, for example, and water can be added in stoichiometrically required amounts, and also the base can be added. The hydrolysis may take place as described above with gentle heating. Alternatively it is also possible, following hydrolysis in water, to perform a solvent exchange.

Copolymers which comprise derivatives of monoethylenically unsaturated dicarboxylic acids (c2b) can be prepared in principle by two different synthesis pathways. On the one hand it is possible to employ the derivatives (c2b) as monomers for the actual polymerization. These monomers may be prepared beforehand in a separate synthesis step from the functional alcohols (I) and/or the functional amines (II) and also the dicarboxylic acids or, preferably, their anhydrides.

In one preferred embodiment of the inventions first copolymers are prepared, as described above, from the monomers (c1) and also the non-derivatized ethylenically unsaturated dicarboxylic acids (c2a). Preferably the dicarboxylic acids for this purpose are used—where possible—in the form of their internal anhydrides, particular preference being given to the use of maleic anhydride. After the copolymer has formed it is possible with this synthesis variant to react the copolymerized dicarboxylic acid units, preferably the corresponding dicarboxylic anhydride units, and more preferably the maleic anhydride units, in a polymer-analogous reaction with the functional alcohols HO—R¹—X²ₙ (I) and/or ammonia and/or the functional amines HR²N—R¹—X²ₙ (II).

The reaction may be performed in bulk (without solvent) or, preferably, in a suitable aprotic solvent. Examples of suitable aprotic solvents comprise, in particular, polar aprotic solvents such as acetone, methyl ethyl ketone (MEK), dioxane or THF and also, if appropriate, nonpolar hydrocarbons such as toluene or aliphatic hydrocarbons.

For the reaction the non-modified copolymer can for example be introduced into the reaction vessel in a solvent, and subsequently the desired functional alcohol HO—R¹—X²ₙ (I), ammonia or the desired functional amine HR²N—R¹—X²ₙ (II) can be added in the desired quantity. The reagents for the functionalization may advantageously be dissolved beforehand in a suitable solvent. The derivatization is preferably carried out with heating. Reaction times which have been found appropriate are 2 to 25 h. When using primary amines or ammonia, at temperatures of up to 100° C., the corresponding amides are obtained preferentially, whereas increasingly, at higher temperatures, imides are formed as well. At 130 to 140° C. the formation of imides is already predominant. With preference the formation of imide structures ought to be avoided.

The quantities of the reagents used with functionalization are guided by the desired degree of functionalization. A quantity which has been found appropriate is from 0.5 to 1.5 equivalents per dicarboxylic acid unit, preferably 0.6 to 1.2, more preferably 0.8 to 1.1, and very preferably about 1 equivalent. If less than 1 equivalent is used, remaining anhydride groups may be opened hydrolytically in a second step.

It is of course also possible to use mixtures of two or more functional alcohols HO—R¹—X²ₙ (I) and/or ammonia, or the functional amines HR²N—R¹—X²ₙ (II), respectively. Also possible are reaction sequences in which reaction takes place first of all with an alcohol/ammonia/amine and after that reaction a further alcohol/ammonia/amine component is used for reaction.

The organic solutions of the modified copolymers that are obtained can be used directly to formulate organic crosslinkable preparations. It will be appreciated that it is also possible, however, to isolate the polymers from these solutions, by methods known to the skilled worker.

For incorporation into aqueous formulations water can be added appropriately to the solution and the organic solvent can be separated off by means of methods known to the skilled worker.

It is also possible for some or all of the acidic groups of the polymer to be neutralized. The pH of the copolymer solution ought in general to be at least 6, preferably at least 7, in order to ensure sufficient solubility or dispersibility in water. In the case of nonfunctionalized copolymers this figure corresponds approximately to one equivalent of base per dicarboxylic acid unit. In the case of functionalized copolymers the functional groups X¹ or X² of course affect the solubility properties of the copolymer. Examples of suitable bases for neutralizing comprise ammonia, alkali metal and alkaline earth metal hydroxides, zinc oxide, linear, cyclic and/or branched C₁-C₈ mono-, di-, and trialkylamines, linear or branched C₁-C₈ mono-, di- or trialkanolamines, especially mono-, di- or trialkanolamines, linear or branched C₁-C₈ alkyl ethers of linear or branched C₁-C₈ mono-, di- or trialkanolamines, oligoamines and polyamines such as diethylenetriamine, for example. The base can be used subsequently or, with advantage, actually during the hydrolysis of anhydride groups.

The molecular weight M_{w} of the copolymer is chosen by the skilled worker in accordance with the desired end use. An M_{w} of 1000 to 100,000 g/mol has been found appropriate, preferably 1500 to 50,000 g/mol, more preferably 2000 to 20,000 g/mol, very preferably 3000 to 15,000 g/mol, and, for example, 8000 to 14,000 g/mol.

To produce the integrated pretreatment layers it is possible to use a single copolymer (C) or else two or more different copolymers (C). From among those copolymers (C) which are possible in principle the skilled worker will make a specific selection in accordance with the desired properties of the integrated pretreatment layer. For the skilled worker it is obvious that not all kinds of copolymers (C) are equally suitable for all kinds of binder systems, solvent or metallic surfaces.

The copolymers (C) used in accordance with the invention are typically employed in a quantity of 0.25% to 40% by weight, preferably 0.5% to 30% by weight, more preferably 0.7% to 20% by weight, and very preferably 1.0% to 10% by weight, based on the quantity of all components of the formulation bar the solvent.

As component (D) the preparation generally comprises a suitable solvent, in which the components are in solution and/or dispersion, in order to allow uniform application of the preparation to the surface. The solvents are generally removed before the coating is cured. It is also possible in principle, however, to formulate a solvent-free or substantially solvent-free preparation. In this case the preparations in question are, for example, powdercoating materials or photochemically curable preparations.

Suitable solvents are those capable of dissolving, dispersing, suspending or emulsifying the compounds of the invention. They may be organic solvents or water. As will be appreciated, mixtures of different organic solvents or mixtures of organic solvents with water can also be used. Among the solvents that are possible in principle the skilled worker will make an appropriate selection in accordance with the desired end use and with the identity of the compound of the invention used.

Examples of organic solvents comprise hydrocarbons such as toluene, xylene or mixtures such as are obtained in the refining of crude oil, such as, for example, defined-boiling-range hydrocarbon fractions, ethers such as THF or polyethers such as polyethylene glycol, ether alcohols such as butyl glycol, ether glycol acetates such as butyl glycol acetate, ketones such as acetone, and alcohols such as methanol, ethanol or propanol.

In addition it is also possible to use formulations which comprise water or a predominantly aqueous solvent mixture. By this are meant those mixtures which comprise at least 50% by weight, preferably at least 65% by weight, and more preferably at least 80% by weight of water. Further components are water-miscible solvents. Examples comprise monoalcohols such as methanol, ethanol or propanol, higher alcohols such as ethylene glycol or polyether polyols, and ether alcohols such as butyl glycol or methoxypropanol.

The quantity of the solvents is selected by the skilled worker in accordance with the desired properties of the preparation and with the desired application method. As a general rule the weight ratio of the layer components to the solvent is 10:1 to 1:10, preferably about 2:1, without any intention that the invention should be restricted thereto. It is, of course, also possible first to prepare a concentrate and to dilute it to the desired concentration only when on site.

The preparation is prepared by intensively mixing the components of the preparation with—where used—the solvents. Suitable mixing or dispersing assemblies are known to the skilled worker. The copolymers are used preferably in the form of the solutions or emulsions obtained in the hydrolytic opening of the anhydride groups and/or the derivatization and also, if appropriate, solvent exchange. Solvents in these synthesis stages should be selected so as to be at least compatible with the binder system that is to be used; with particular advantage the solvent used is the same.

In addition to components (A) to (C) and also, optionally, (D), the preparation may further comprise one or more auxiliaries and/or additives (E). The purpose of such auxiliaries and/or additives is to fine-tune the properties of the layer. Their quantity generally does not exceed 20% by weight relative to the sum of all components bar the solvents, and preferably does not exceed 10%.

Examples of suitable additives are color and/or effect pigments, rheological assistants, UV absorbers, light stabilizers, free-radical scavengers, free-radical addition-polymerization initiators, thermal-crosslinking catalysts, photoinitiators and photocoinitiators, slip additives, polymerization inhibitors, defoamers, emulsifiers, devolatilizers, wetting agents, dispersants, adhesion promoters, flow control agents, film-forming auxiliaries, rheology control additives (thickeners), flame retardants, siccatives, antiskinning agents, other corrosion inhibitors, waxes, and matting agents, as are known from the textbook >>Lackadditive<< [Additives for coatings] by Johan Bieleman, Wiley-VCH, Weinheim, New York, 1998, or from German patent application DE 199 14 896 A1, column 13 line 56 to column 15 line 54.

To implement the process of the invention the preparation is applied to the metallic surface.

As an option the surface can be cleaned prior to treatment. Where the treatment of the invention takes place immediately after a metallic surface treatment, such as an electrolytic galvanization or a hot-dip galvanization of steel coils, then the coils may generally be contacted with the treatment solution of the invention, without prior cleaning. Where, however, the metal coils for treatement have been stored and/or transported prior to coating in accordance with the invention, they generally carry or are soiled with corrosion control oils, so necessitating cleaning prior to coating in accordance with the invention. Cleaning can take place by methods known to the skilled worker, using customary cleaning agents.

The preparation can be applied by, for example, spraying, dipping, pouring or roller application. After a dipping operation the workpiece can be left to drip-dry, in order to remove excess preparation; in the case of metal sheets, foils or the like it is also possible to remove excess preparation by squeezing off or squeegeeing. Application with the preparation takes place generally at room temperature, although this is not intended to rule out the possibility in principle of higher temperatures.

The process of the invention is preferably used to coat metal coils. In this coil-coating operation, coating may be performed either on one side or on both sides. It is also possible to coat the top and bottom faces using different formulations.

With very particular preference, coil coating takes place by means of a continuous process. Continuous coil-coating lines are known in principle. They generally comprise at least one coating station, a drying or baking station and/or UV station, and, if appropriate, further stations for pretreatment or aftertreatment, such as rinsing or afterrinsing stations, for example. Examples of coil-coating lines are found in Rōmpp Lexikon Lacke und Druckfarben, Georg Thieme Verlag, Stuttgart, New York, 1998, page 55, “Coilcoating”, or in German patent application DE 196 32 426 A1. It will be appreciated that lines with a different construction can also be employed.

The speed of the metal coil is selected by the skilled worker in accordance with the application and curing properties of the preparation employed. Speeds which have been found appropriate are generally from 10 to 200 m/min, preferably 12 to 120 m/min, more preferably 14 to 100 m/min, very preferably 16 to 80, and in particular 20 to 70 m/min.

For application to the metal coil the crosslinkable preparation employed in accordance with the invention can be applied by spraying, pouring, or, preferably, by roller application. In the case of the preferred roll coating, the rotating pick-up roll dips into a reservoir of the inventively employed preparation and so picks up the preparation to be applied. This material is transferred from the pick-up roll to the rotating application roll directly or via at least one transfer roll. The coating material is stripped from this application roll and so transferred to the coil as it runs in the same or opposite direction. In accordance with the invention the opposite-direction stripping, or reverse roller-coating method, is of advantage and is therefore employed with preference. The circumferential speed of the application roll is preferably 110% to 125% of the coil speed, and the peripheral speed of the pick-up roll is 20% to 40% of the coil speed. The inventively employed preparation can alternatively be pumped directly into a gap between two rolls, this being referred to by those in the art as nip feed.

Following the application of the inventively employed preparation, any solvent present in the layer is removed and the layer is crosslinked. This can take place in two separate steps or else simultaneously. To remove the solvent, the layer is preferably heated by means of an appropriate apparatus. Drying can also take place by contacting with a stream of gas. The two methods can be combined.

The method of curing is guided by the nature of the binder system employed. It may take place thermally and/or photochemically.

In the case of thermal crosslinking, the applied coating is heated. This can be accomplished preferably by convection heat transfer, irradiation with near or far infrared, and/or, in the case of iron-based coils, by electrical induction.

The temperature required for curing is guided in particular by the crosslinkable binder system employed. Highly reactive binder systems may be cured at lower temperatures than less reactive binder systems. As a general rule the crosslinking is performed at temperatures of at least 60° C., preferably at least 80° C., more preferably at least 100° C., and very preferably at least 120° C. In particular the crosslinking can be performed at 100 to 250° C., preferably 120 to 220° C., and more preferably at 150 to 200° C. The temperature referred to in each case is the peak metal temperature (PMT), which can be measured by methods familiar to the skilled worker (for example, contactless infrared measurement or temperature determination with adhered test strips).

The heating time, i.e., the duration of the thermal cure, varies depending on the coating material employed in accordance with the invention. The time is preferably 10 s to 2 min. Where essentially convection heat transfer is employed, the need is for forced-air ovens with a length of 30 to 50 m, in particular 35 to 45 m, at the preferred coil speeds. The forced-air temperature is of course higher than the temperature of the layer and can amount to up to 350° C.

Photochemical curing takes place by means of actinic radiation. By actinic radiation is meant, here and below, electromagnetic radiation, such as near infrared, visible light, UV radiation or x-rays, or particulate radiation, such as electron beams. For photochemical curing it is preferred to employ UV/VIS radiation. Irradiation may also be carried out, if appropriate, in the absence of oxygen, such as under an inert-gas atmosphere. The photochemical cure may take place under standard temperature conditions, i.e., without the coating being heated, or alternatively photochemical crosslinking can take place at elevated temperatures of, for example, 40 to 150° C., preferably 40 to 130° C., and in particular at 40 to 100° C.

As a result of the process of the invention it is possible to obtain an integrated pretreatment layer on a metallic surface, particularly the surface of iron, steel, zinc or zinc alloys, aluminum or aluminum alloys. The precise structure and composition of the integrated pretreatment layer is not known to us. Besides the crosslinked binder system (A) it comprises the fillers, the copolymers (C), and, optionally, further components. In addition there may also be components present that have been extracted from the metal surface and deposited again, such as typical amorphous oxides of aluminum or of zinc and also, if appropriate, of further metals.

The thickness of the integrated pretreatment layer is 1 to 25 μm and is determined by the skilled worker in accordance with the desired qualities and the end use of the layer. In general a thickness of 3 to 15 μm has been found appropriate for integrated pretreatment layers. A thickness of 4 to 10 μm is preferred, while 5 to 8 μm are particularly preferred. The thickness depends on the quantity of composition applied in each case.

In case of applications in the automobile segment the application of the integrated pretreatment layer of the invention may under certain circumstances not in fact be followed by cathodic dip coating. If the integrated pretreatment layer is also intended to replace the cathodic electrocoat, somewhat thicker integrated pretreatment layers are advisable, with a thickness for example of 10 to 25 μm, preferably 12 to 25 μm.

Atop the metallic surface provided with an integrated pretreatment layer it is also possible for further coating films to be applied. The nature and number of the coating films required are determined by the skilled worker in accordance with the desired use of the coated metal or shaped metallic part. The integrated pretreatment layers of the invention lend themselves well to overcoating and enjoy good adhesion with the subsequent coating films. Further coating films may include, for example, films of color coating, clearcoating or functional coating materials. One example of a functional coating material is a soft coating material having a relatively high filler content. This coating material can be applied advantageously before the color coating and/or topcoating material, in order to protect the metal and the integrated pretreatment layer against mechanical damage, caused by stonechipping or scratching, for example.

The application of further coating films may be implemented on the coil-coating line described. In that case two or more application stations and also, optionally, curing stations are placed in series. Alternatively, after the corrosion control coat has been applied and cured, the coated coil can be rolled up again and further coats can be applied only at a later point in time, on other lines. The further-processing of the coated metal coils may take place on site, or they may be transported to a different site for further-processing. For this purpose they may be provided with, for example, removable protective sheets.

Coils which have been provided with an integrated pretreatment layer can alternatively first be processed—by means of cutting, shaping, and joining, for example—to form shaped metallic parts. The joining may also be accomplished by means of welding. After that the shaped article obtained can be provides as described above with further coating films.

The invention hence also provides shaped articles having a metallic surface coated with an integrated pretreatment layer having a thickness of 1 to 25 μm, and shaped articles additionally possessing further coating films. The term “shaped article” is intended here to comprise coated metal panels, foils or coils, and also the metallic components obtained from them.

Such components are in particular those that can be used for paneling, facing or lining. Examples comprise automobile bodies or parts thereof, truck bodies, frames for two-wheelers such as motorcycles or pedal cycles, or parts for such vehicles, such as fairings or panels, casings for household appliances such as washing machines, dishwashers, laundry dryers, gas and electric ovens, microwave ovens, freezers or refrigerators, paneling for technical instruments or installations such as, for example, machines, switching cabinets, computer housings or the like, structural elements in the architectural segment, such as wall parts, facing elements, ceiling elements, window profiles, door profiles or partitions, furniture made from metallic materials, such as metal cupboards, metal shelves, parts of furniture, or else fittings. The components may additionally be hollow articles for storage of liquids or other substances, such as, for example, tins, cans or tanks.

The examples which follow are intended to elucidate the invention in more detail.

### Part A—Synthesis of Copolymers Employed

### Part I—Synthesis of Copolymers Containing Anhydride Groups

Copolymer A

Copolymer of MAn/C₁₂ olefin (molar ratio 1/1)

A 2 l pilot-scale stirrer is charged with 176.4 g (1.05 mol) of n-dodec-1-ene, gassed with nitrogen, and heated to 150° C. Over the course of 6 h a feedstream 1 of 147.1 g of melted maleic anhydride (MAn; 80° C., 1.50 mol) and a feedstream 2 of 4.1 g of di-tert-butyl peroxide (1% based on monomers) in 75.6 g (0.45 mol) of n-dodec-1-ene are added dropwise. The reaction mixture is stirred at 150° C. for a further 2 h. This gives a pale yellowish, solid resin.

Copolymer B

Copolymer of MAn/C₁₂ olefin/styrene (molar ratio 1/0.9/0.1)

The procedure of inventive example 1 was repeated, but using a mixture of 1.35 mol of n-dodec-1-ene and 0.15 mol of styrene rather than n-dodec-1-ene alone.

Copolymer C

Copolymer of MAn/C₁₂ olefin/C₂₀₋₂₄ olefin (molar ratio 1/0.6/0.4)

A 1500 l pressure reactor with anchor stirrer, temperature monitoring, and nitrogen inlet is charged by pumped introduction at 60° C. with 36.96 kg of C₂₀₋₂₄ olefin and by suction with 31.48 kg of n-dodec-1-ene. The initial charge is heated to 150° C. Then over the course of 6 h feedstream 1, consisting of 1.03 kg of di-tert-butyl peroxide, and feedstream 2, consisting of 30.57 kg of melted maleic anhydride, are metered in. After the end of feedstreams 1 and 2 the batch is stirred at 150° C. for 2 h. Subsequently acetone and tert-butanol are removed by distillation at 150-200 mbar.

Copolymer D

Copolymer of MAn/C₁₂ olefin/polyisobutene 550 (molar ratio 1/0.8/0.2)

In a 2 l pilot-scale stirrer with anchor stirrer and internal thermometer 363 g (0.66 mol) of high-reactivity polyisobutene (α-olefin content >80%) having an Mₙ of 550 g/mol (Glissopal® 550, BASF) and 323.4 g (2.11 mol) of C₁₂ olefin are heated to 150° C. with stirring and introduction of nitrogen. Subsequently over the course of 6 h a feedstream 1, consisting of 323.4 g of maleic anhydride (80° C., 3.3 mol), and feedstream 2, consisting of 13.56 g of di-tert-butyl peroxide (1% based on monomers) and 88.8 g (0.53 mol) of C₁₂ olefin, are metered in. After the end of feedstreams 1 and 2 the batch is stirred at 150° C. for a further 2 h. This gives a solid yellowish polymer.

Copolymer E

Copolymer of MAn/C₁₂ olefin/polyisobutene 1000 (molar ratio 1/0.8/0.2)

In a 2 l pilot-scale stirrer with anchor stirrer and internal thermometer 600.0 g (0.6 mol) of high-reactivity polyisobutene (α-olefin content >80%) having an Mₙ of 1000 g/mol (Glissopal® 1000, BASF) and 322.5 g (1.92 mol) of C₁₂ olefin are heated to 150° C. with stirring and introduction of nitrogen. Subsequently over the course of 6 h a feedstream 1, consisting of 294.0 g of maleic anhydride (80° C., 3.0 mol), and feedstream 2, consisting of 13.0 g of di-tert-butyl peroxide (1% based on monomers) and 80.6 g (0.48 mol) of C₁₂ olefin, are metered in. After the end of feedstreams 1 and 2 the batch is stirred at 150° C. for a further 2 h. This gives a solid yellowish polymer.

Copolymer F

Copolymer of MAn/C₁₂ olefin/10-undecenoic acid (molar ratio 1/0.9/0.1)

A 2 l pilot-scale stirrer is charged with 554.4 g (3.3 mol) of n-dodec-1-ene and 8.293 g (0.45 mol) of 10-undecenoic acid, gassed with nitrogen, and heated to 150° C. Over the course of 6 h a feedstream 1 of 441 g of melted maleic anhydride (80° C., 4.5 mol) and a feedstream 2 of 12 g of di-tert-butyl peroxide (1% based on monomers) in 126 g (0.75 mol) of n-dodec-1-ene are added dropwise. The reaction mixture is stirred at 150° C. for a further 2 h. This gives a pale yellowish, solid resin.

Copolymer G

Copolymer of MAn/C₈ olefin (molar ratio 1/1)

The procedure of inventive example 1 was repeated but using n-oct-1-ene instead of n-dodec-1-ene.

### Part II—Hydrolytic Ring Opening of the Resins/Solvent Exchange

General Experimental Instructions II-1

400 g of each of the copolymer resins A to G employed, containing anhydride groups, are comminuted and suspended in 1000 g of water in a 2 l pilot-scale stirrer, and the suspension is heated to 100° C. Over the course of an hour 1 equivalent of base (based on the maleic anhydride groups in the resin) is added dropwise and the mixture is stirred at 100° C. for a further 6 h until a solution or stable emulsion has been obtained.

Solvent Exchange II-2

350 g of the aqueous solution from instructions 1 are admixed in a reaction vessel with 400 g of butyl glycol. Subsequently the water is removed by distillation under reduced pressure at 50 to 60° C.

Further details of the specific polymers employed, the bases, and the properties of the polymers obtained are compiled in table 1.

### Part III—Functionalization of the Copolymers

General Experimental Instructions III-1

A 2 l pilot-scale stirrer with anchor stirrer and internal thermometer is charged with the particular desired maleic anhydride-olefin copolymer A to G in an organic solvent, and gassed with nitrogen. Then 1 equivalent of each of the desired hydroxy-functional or amino-functional compounds (I) or (II) is added dropwise over the course of x hours at y° C.

Solvent Exchange:

Following the derivatization it is possible to carry out an exchange of the organic solvent for water. For this purpose the product is admixed with water and base until the desired pH is reached. Subsequently the organic solvent is distilled off under reduced pressure.

General Experimental Instructions III-2

A 2 l pilot-scale stirrer with anchor stirrer and internal thermometer is charged with the particular desired maleic anhydride-olefin copolymer A to G and 1 equivalent of each of the desired hydroxy-functional or amino-functional compounds (I) or (II), gassed with nitrogen, and stirred for x hours y° C. Subsequently the product is taken up in a suitable organic solvent.

Following the derivatization it is possible to carry out an exchange of the organic solvent for water, as described.

Further details of each of the polymers employed, the hydroxy-functional or amino-functional compound (I) or (II) employed, and the properties of the derivatized copolymers obtained are compiled in table 2.

TABLE 1
Aqueous emulsions of copolymers with unmodified dicarboxylic acid units by hydrolytic ring opening in accordance with
general instructions II-1

| | Starting | | | | | | | |
|---|---|---|---|---|---|---|---|---|
| | material | | | | | | Solids content | |
| Copolymer No. | employed | Description | Molar ratio | Base | Solvent | K value | [% by weight] | pH |
| Copolymer 1 | A | MAn/C₁₂ olefin | 1/1 | Dimethylethanolamine | Water | — | 28.7 | 8.3 |
| Copolymer 1a | A | MAn/C₁₂ olefin | 1/1 | Dimethylethanolamine | Butyl glycol* | 14.4 | 22 | — |
| Copolymer 2 | B | MAn/C₁₂ olefin/styrene | 1/0.9/0.1 | Dimethylethanolamine | Water | 24.8 | 27.0 | 8.4 |
| Copolymer 3 | C | MAn/C₁₂ olefin/C₂₀₋₂₄ olefin | 1/0.6/0.4 | Ethanolamine | Water | — | 17.4 | 8.3 |
| Copolymer 4 | D | MAn/C₁₂ olefin/PIB550 | 1/0.8/0.2 | Dimethylethanolamine | Water | 33.5 | 22.0 | 8.5 |
| Copolymer 5 | E | MAn/C₁₂ olefin/PIB1000 | 1/0.8/0.2 | Dimethylethanolamine | Water | 22.6 | 26.8 | 8.3 |
| Copolymer 5a | E | MAn/C₁₂ olefin/PIB1000 | 1/0.8/0.2 | Dimethylethanolamine | Butyl glycol* | 14.1 | 18.5 | — |
| Copolymer 6 | F | MAn/C₁₂ olefin/undecenoic acid | 1/0.9/0.1 | Dimethylethanolamine | Water | — | 25.2 | — |
| Copolymer 6a | F | MAn/C₁₂ olefin/undecenoic acid | 1/0.9/0.1 | Dimethylethanolamine | Butyl glycol* | — | 41.2 | — |
| Copolymer 7a | G | MAn/C₈ olefin | 1/1 | Dimethylethanolamine | Butyl glycol* | — | 19.4 | — |

Notes:
The K values were each determined by the method of H. Fikentscher, Cellulose-Chemie, Vol. 13, pp. 58-64 and 71-74 (1932) in 1% strength by weight solution (aqueous solution or butyl glycol) at 25° C. with uncorrected pH. The greater the K value the greater the molecular weight of the polymer.
*Solvent exchange after hydrolysis in water - data not determined

TABLE 2
Copolymers derivatized with functionalized alcohols (I) or amines (II)

| | Starting | | | | | | | | Solids | |
|---|---|---|---|---|---|---|---|---|---|---|
| | material | | | | Functional alcohol (I) | Molar | Time | Temp. | content [% | |
| Copolymer No. | employed | Instructions | Solvent | Base | or functional amine (II) | ratio | [h] | [° C.] | by weight] | pH |
| Copolymer 8 | C | 2 | Dioxane/MEK | DMEA | Hydroxypropionic thioamide | 1:1 | 4 | 100 | 25.1 | 8.7 |
| | | | Solvent exchange | to pH 8.7 | | | | | | |
| | | | with H₂O | | | | | | | |
| Copolymer 9 | C | 2 | MEK | DMEA | Mercaptoethanol | 1:0.8 | 16 | 90 | 23.3 | 8.4 |
| | | | Solvent exchange | to pH 8.7 | | | | | | |
| | | | with H₂O | | | | | | | |
| Copolymer 10 | C | 1 | MEK | — | 2-(2-Aminoethoxy)ethanol | 1:1 | 3 | 78 | 43.0 | — |
| Copolymer 11 | E | 1 | MEK | — | Aminocapronitrile | 1:1 | 3 | 66 | 48.2 | — |
| Copolymer 12 | E | 2 | MEK | — | Hydroxypropionic thioamide | 1:1 | 3 | 105 | 47.7 | — |
| Copolymer 13 | E | 2 | MEK | DMEA | Hydroxypropionic thioamide | 1:1 | 3 | 105 | 19.5 | 8.2 |
| | | | Solvent exchange | to pH 8.2 | | | | | | |
| | | | with H₂O | | | | | | | |
| Copolymer 14 | E | 2 | Dioxane/MEK | — | Mercaptoethanol | 1:0.8 | 25 | 95-99 | 54.4 | — |
| Copolymer 15 | E | 2 | None, addition of | DMEA | (Hydroxyethyl)aminobis- | 1:1 | 4.5 | 103 | 20.5 | n.d. |
| | | | H₂O/DMEA | | methylenephosphonic | | | | | |
| | | | Solvent exchange | | acid tetra(tri- | | | | | |
| | | | with BG | | ethylammonium) salt | | | | | |

DMEA: Dimethylethanolamine,
MEK: methyl ethyl ketone,
BG: butyl glycol

### Part B—Performance Tests

The non-derivatized and derivatized maleic acid-olefin copolymers obtained were used to conduct performance experiments. Tests were carried out in three different coil-coating materials, based on epoxides, acrylates, and polyurethanes.

### Base Formula for Coil-Coating Material (Organic) Based on Epoxy Binders

For the formulation for producing an integrated pretreatment layer the following components were employed:

| | | Quantity |
|---|---|---|
| Component | Description | [parts by weight] |
| Binder with | Epoxy binder based on bisphenol A (molecular | 26.9 |
| crosslinking | weight 1000 g/mol, viscosity 13 dPas/s, and 50% | |
| groups | solids content) | |
| Fillers | Hydrophilic pyrogenic silica (Aerosil ® 200V, Degussa) | 0.16 |
| | Talc Finntalc M5 | 2.9 |
| | White pigment titanium rutile 2310 | 10.8 |
| | Silica modified with calcium ions (Shieldex ®, Grace Division) | 3.0 |
| | Zinc phosphate (Sicor ® ZP-BS-M, Waardals Kjemiske | 4.1 |
| | Fabriken) | |
| | Black pigment (Sicomix ® Schwarz, BASF AG) | 1.0 |
| Solvent | Butyl glycol | 5.0 |

The components were mixed in the stated order in a suitable stirring vessel and predispersed for 10 minutes using a dissolver. The resulting mixture was transferred to a beadmill with cooling jacket, and mixed with 1.8-2.2 mm SAZ glass beads. The millbase was ground for 1 h 30′ minutes. Subsequently the millbase was separated from the glass beads.

Added to the millbase with stirring, in the order stated, were 5.9 parts by weight of a blocked hexamethylene diisocyanate (Desmodur® VP LS 2253, Bayer AG) and 0.4 part by weight of a commercial tin-free crosslinking catalyst (Borchi® VP 0245, Borchers GmbH).

### Base Formula for Coil-Coating Material (Aqueous) Based on Acrylate Binder

The crosslinkable binder used was an anionically amine-stabilized, aqueous acrylate dispersion (solids content 30% by weight) formed from n-butyl acrylate, styrene, acrylic acid, and hydroxypropyl methacrylate as principal monomers.

In a suitable stirred vessel, in the order stated, 18.8 parts by weight of the acrylate dispersion, 4.5 parts by weight of a dispersing additive, 1.5 parts by weight of a flow control agent with defoamer action, 5.5 parts by weight of a melamine resin crosslinker (Luwipal® 072, BASF AG), 0.2 part by weight of a hydrophilic pyrogenic silica (Aerosil® 200V from Degussa), 3.5 parts by weight of Finntalk M5 talc, 12.9 parts by weight of titanium rutile 2310 white pigment, 8.0 parts by weight of the acrylate dispersion, 3.5 parts by weight of silica modified with calcium ions (Shieldex® from Grace Division), 4.9 parts by weight of zinc phosphate (Sicor® ZP-BS-M from Waardals Kjemiske Fabriken), 1.2 parts by weight of black pigment (Sicomix® Schwarz from BASF AG) were mixed and the mixture was predispersed for 10 minutes using a dissolver. The resulting mixture was transferred to a beadmill with cooling jacket and mixed with 1.8-2.2 mm SAZ glass beads. The millbase was ground for 45 minutes. Then the millbase was separated from the glass beads.

Added to the millbase with stirring, in the order stated, were 27 parts by weight of the acrylate dispersion, 1.0 part by weight of a defoamer, 3.2 percent of a blocked sulfonic acid, 1.5 parts by weight of a defoamer, and 1.0 part by weight of a flow control assistant.

### Base Formula for Coil-Coating Material (Aqueous) Based on Polyurethane Binder

The crosslinkable binder used was an aqueous polyurethane dispersion (solids content 44% by weight, acid number 25, Mₙ about 8000 g/mol, M_{w} about 21,000 g/mol) based on polyester diols as soft segment (Mₙ about 2000 g/mol), 4,4′-bis(isocyanatocyclo-hexyl)methane, and also monomers containing acidic groups, and chain extenders.

In a suitable stirred vessel, in the order stated, 18.8 parts by weight of the polyurethane dispersion, 4.5 parts by weight of a dispersing additive, 1.5 parts by weight of a flow control agent with defoamer action, 5.5 parts by weight of a melamine resin crosslinker (Luwipal® 072, BASF AG), 0.2 part by weight of a hydrophilic pyrogenic silica (Aerosil® 200V from Degussa), 3.5 parts by weight of Finntalk M5 talc, 12.9 parts by weight of titanium rutile 2310 white pigment, 8.0 parts by weight of the polyurethane dispersion, 3.5 parts by weight of silica modified with calcium ions (Shieldex® from Grace Division), 4.9 parts by weight of zinc phosphate (Sicor® ZP-BS-M from Waardals Kjemiske Fabriken), 1.2 parts by weight of black pigment (Sicomix® Schwarz from BASF AG) were mixed and the mixture was predispersed for 10 minutes using a dissolver. The resulting mixture was transferred to a beadmill with cooling jacket and mixed with 1.8-2.2 mm SAZ glass beads. The millbase was ground for 45 minutes. Then the millbase was separated from the glass beads.

Added to the millbase with stirring, in the order stated, were 27 parts by weight of the polyurethane dispersion, 1.0 part by weight of a defoamer, 3.2 percent of an acidic catalyst (blocked p-toluenesulfonic acid, Nacure 2500), 1.5 parts by weight of a defoamer, and 1.0 part by weight of a flow control assistant.

Addition of the Copolymers used in Accordance with the Invention

The coil-coating materials described were each admixed with 5% by weight of the above-described derivatized or non-derivatized copolymers (calculated as solid copolymer with respect to the solid components of the formulation). For the organic coating material based on epoxides the above-described solutions of the copolymers in butyl glycol were employed for this purpose; for the aqueous coating materials based on acrylates or epoxides, the aqueous solutions or emulsions described were employed for this purpose.

### Coating of Steel and Aluminum Panels

The coating experiments were carried out using galvanized steel plates of type Z (OEHDG 2, Chemetall) and aluminum plates AlMgSi (AA6016, Chemetall). These plates had been cleaned beforehand by known methods.

The coil-coating materials described were applied using rod-type doctor blades in a wet film thickness which resulted, after curing in a continuous dryer at a forced-air temperature of 185° C. and a substrate temperature of 171° C., in coatings with a dry layer thickness of 6 μm.

For comparison purposes, coatings without the addition of the copolymers were also produced.

In order to test the corrosion inhibition effect of the coatings of the invention, the galvanized steel sheets were subjected for 10 weeks to the VDA climatic cycling test (VDA [German Association of the Automotive Industry] test sheet 621-415 Feb 82).

In this test (see drawing below) the samples are first exposed to a salt spray test for one day (5% NaCl solution, 35° C.) and subsequently exposed 3× in alternation to humid conditions (40° C., 100% relative humidity) and dry conditions (22° C., 60% relative humidity). A cycle is ended with a 2-day dry-conditions phase. A cycle is depicted schematically below.

A total of 10 such exposure cycles are carried out in succession.

After the end of the corrosion exposure, steel plates were evaluated visually by comparison with predefined standards. Assessments were made both with the formation of corrosion products on the undamaged coating area, and of the propensity for subfilm corrosion at the edge and at the scribe mark.

The samples were evaluated on the basis of a comparison with the comparison sample without addition of the corrosion-inhibiting copolymers.

The corrosion inhibition effect of the steel plates was additionally performed by means of a salt spray test in accordance with DIN 50021.

Aluminum plates were subjected to the ethanoic acid salt spray test ESS (DIN 50021, Jun 88). After the end of corrosion exposure the panels were evaluated visually. In this case evaluation was made of the areas of circular delamination over the coating area as a whole.

For all the tests the coating films were inscribed; in the case of the steel plates, inscribing took place through the zinc layer and down to the steel layer.

For the evaluation of the samples the following scores were awarded:
0 corrosion damage as for the blank sample
+ less corrosion damage than the blank sample
++ substantially less corrosion damage than the blank sample
− more corrosion damage than the blank sample

The results of the tests are depicted schematically in tables 3 to 5.

TABLE 3
Corrosion experiments with copolymers having non-derivatized dicarboxylic acid units

| | | | | | Steel panel, galvanized | | Aluminum panel |
|---|---|---|---|---|---|---|---|
| Example | Copolymer | | | | Climatic | | Ethanoic acid |
| No. | employed | Monomers | Molar ratio | Coating system | cycling test | Salt spray test | salt spray test |
| Example 1 | Copolymer 1 | MAn/C₁₂ olefin | 1/1 | Acrylate/H₂O | 0 | + | + |
| Example 2 | Copolymer 1 | MAn/C₁₂ olefin | 171 | Polyurethane/H₂O | not tested | 0 | + |
| Example 3 | Copolymer 1a | MAn/C₁₂ olefin | 1/1 | Epoxy/butyl glycol | ++ | + | 0 |
| Example 4 | Copolymer 2 | MAn/C₁₂ olefin/styrene | 1/0.9/0.1 | Acrylate/H₂O | 0 | + | + |
| Example 5 | Copolymer 3 | MAn/C₁₂ olefin/C₂₀₋₂₄ olefin | 1/0.6/0.4 | Polyurethane/H₂O | 0 | not tested | ++ |
| Example 6 | Copolymer 4 | MAn/C₁₂ olefin/PIB 550 | 1/0.8/0.2 | Acrylate/H₂O | 0 | + | + |
| Example 7 | Copolymer 5 | MAn/C₁₂ olefin/PIB 1000 | 1/0.8/0.2 | Acrylate/H₂O | 0 | + | + |
| Example 8 | Copolymer 5 | MAn/C₁₂ olefin/PIB 1000 | 1/0.8/0.2 | Polyurethane/H₂O | + | not tested | + |
| Example 9 | Copolymer 6 | MAn/C₁₂ olefin/undecenoic acid | 1/0.9/0.1 | Acrylate/H₂O | + | + | + |
| Example 10 | Copolymer 6 | MAn/C₁₂ olefin/undecenoic acid | 1/0.9/0.1 | Polyurethane/H₂O | ++ | + | ++ |
| Example 11 | Copolymer 6a | MAn/C₁₂ olefin/undecenoic acid | 1/0.9/0.1 | Epoxy/Butyl glycol | ++ | 0 | ++ |
| Example 12 | Copolymer 7a | MAn/C₈ olefin | 1/1 | Epoxy/Butyl glycol | + | 0 | − |

TABLE 4
Corrosion experiments with copolymers having derivatized dicarboxylic acid units

| | | | | Dicarboxylic | | Steel panel, | Aluminum |
|---|---|---|---|---|---|---|---|
| | | | | acid unit | | galvanized | panel |
| Example | Copolymer | | Molar | Functionalized | | Climatic cycling | Ethanoic acid |
| No. | employed | Monomere | ratio | with | Coating system | test | Salt spray test |
| Example 13 | Copolymer 8 | MAn/C₁₂ olefin/C₂₀₋₂₄ olefin | 1/0.6/0.4 | —CSNH₂ | Acrylate/dioxane/water | 0 | + |
| Example 14 | Copolymer 8 | MAn/C₁₂ olefin/C₂₀₋₂₄ olefin | 1/0.6/0.4 | —CSNH₂ | PU/dioxane/water | 0 | + |
| Example 15 | Copolymer 9 | MAn/C₁₂ olefin/C₂₀₋₂₄ olefin | 1/0.6/0.4 | —SH | Epoxy/MEK | + | + |
| Example 16 | Copolymer 10 | MAn/C₁₂ olefin/C₂₀₋₂₄ olefin | 1/0.6/0.4 | —OH | Epoxy/MEK | + | + |
| Example 17 | Copolymer 11 | MAn/C₁₂ olefin/PIB 1000 | 1/0.8/0.2 | —CN | Epoxy/MEK | + | + |
| Example 18 | Copolymer 12 | MAn/C₁₂ olefin/PIB 1000 | 1/0.8/0.2 | —CSNH₂ | Epoxy/MEK | + | + |
| Example 19 | Copolymer 13 | MAn/C₁₂ olefin/PIB 1000 | 1/0.8/0.2 | —CSNH₂ | Acrylate/dioxane/water | No test | + |
| Example 20 | Copolymer 13 | MAn/C₁₂ olefin/PIB 1000 | 1/0.8/0.2 | —CSNH₂ | PU/dioxane/water | 0 | + |
| Example 21 | Copolymer 14 | MAn/C₁₂ olefin/PIB 1000 | 1/0.8/0.2 | —SH | Epoxy/dioxane/water | + | + |
| Example 22 | Copolymer 15 | MAn/C₁₂ olefin/PIB 1000 | 1/0.8/0.2 | —PO₃H | Epoxy/MEK | + | − |

The examples show that inventive use of non-derivatized and derivatized MAn-olefin copolymers makes it possible to achieve improvement in the corrosion control properties of the coil-coating materials. The improvement appears on at least one of the two substrates, aluminum or steel, but as a general rule is observed on both substrates.

Especially good results are achieved using relatively long-chain olefins and also using olefins which additionally contain functional groups.

1. A process for applying an integrated pretreatment layer with a thickness of 1 to 25 μm to the surface of steel, zinc or zinc alloys, aluminum or aluminum alloys, the process comprising:
(1) applying a crosslinkable preparation to the metallic surface, without any corrosion-inhibiting pretreatment being performed beforehand, said preparation comprising at least
(A) 20% to 70% by weight of at least one thermally and/or photochemically crosslinkable binder system (A),
(B) 20% to 70% by weight of at least one inorganic finely divided filler having an average particle size of less than 10 μm,
(C) 0.25% to 40% by weight of at least one corrosion preventative, and
(D) optionally a solvent,
with the proviso that the percentages by weight are based on the sum of all components bar the solvent; and
(2) thermally crosslinking at temperatures above room temperature and/or photochemically crosslinking the applied layer,
wherein the corrosion preventative is at least one copolymer (C) synthesized from the following monomeric structural units:
(c1) 70 to 30 mol % of at least one monoethylenically unsaturated hydrocarbon (c1a) and/or of at least one monomer (c1b) selected from the group of monoethylenically unsaturated hydrocarbons (c1b′), modified with functional groups X¹, and vinyl ethers (c1b″);
(c2) 30 to 70 mol % of at least one monoethylenically unsaturated dicarboxylic acid having 4 to 8 C atoms and/or its anhydride (c2a) and/or derivatives (c2b) thereof, the derivatives (c2b) being esters of the dicarboxylic acid with alcohols of the general formula HO—R¹—X²ₙ (I) and/or amides or imides with ammonia and/or amines of the general formula HR²N—R¹—X²ₙ (II), and the abbreviations having the following definition:
R¹: (n+1)-valent hydrocarbon group having 1 to 40 C atoms, in which nonadjacent C atoms may also be substituted by O and/or N;
R²: H, C₁ to C₁₀ hydrocarbon group or —(R¹—X²ₙ)
n: 1, 2 or 3; and
X²: a functional group; and
(c3) 0 to 10 mol % of other ethylenically unsaturated monomers, different from (c1) and (c2) but copolymerizable with (c1) and (c2),
the amounts being based in each case on the total amount of all monomer units in the copolymer.

2. The process according to claim 1, wherein the metallic surface is the surface of electrolytically galvanized or hot-dip-galvanized steel.

3. The process according to claim 1, wherein the metal surface is the surface of a coil metal and the integrated pretreatment layer is applied by means of a continuous process.

4. The process according to claim 3, wherein coating is performed by means of a rolling, spraying or dipping process.

5. The process according to claim 1, wherein the metallic surface prior to coating with the preparation is cleaned in an additional cleaning step (0).

6. The process according to claim 1, wherein the crosslinking is performed thermally and binder systems selected from the groups of polyesters, epoxy resins, polyurethanes or polyacrylates and also at least one additional crosslinker are employed.

7. The process according to claim 6, wherein the crosslinker is a blocked isocyanate or a reactive melamine resin.

8. The process according to claim 6, wherein crosslinking is performed at a temperature of 100° C. to 250° C.

9. The process according to claim 1, wherein the thickness of the integrated pretreatment layer is 3 to 15 μm.

10. The process according to claim 10, wherein monomer (c2a) is maleic acid and/or maleic anhydride.

11. The process according to claim 1, wherein copolymer (C) comprises at least one monomer of type (c1a).

12. The process according to claim 11, wherein monomers (c1a) are monoethylenically unsaturated hydrocarbons having 6 to 30 C atoms.

13. The process according to claim 12, wherein the copolymer further comprises 1 to 60 mol %, based on the amount of all monomers (c1), of at least one reactive polyisobutene.

14. The process according to claim 12, wherein the copolymer further comprises 1 to 60 mol %, based on the amount of all monomers (c1), of at least one monoethylenically unsaturated hydrocarbon (c1b′) modified with functional groups X¹.

15. The process according to claim 14, wherein the monomer (c1b′) is 10-undecenecarboxylic acid.

16. The process according to claim 13, wherein the monoethylenically unsaturated hydrocarbons have 9 to 27 C atoms.

17. The process according to claim 1, wherein the functional group X² is one selected from the group of —Si(OR³)₃ (with R³═C₁ to C₆ alkyl), —OR⁴, —SR⁴, —NR⁴₂, COOR⁴, —(C═O)R⁴, —COCH₂COOR⁴, —CSNR⁴₂, —CN, —Po₂R⁴₂, —Po₃R⁴₂, —OPO₃R⁴₂, (with R⁴═H, C₁ to C₆ alkyl or aryl) or —SO₃H.

18. The process according to claim 1, wherein the functional group X² is one selected from the group of —OH, —SH, —COOH, —CSNH₂, —CN, —PO₃H₂, —SO₃H or salts thereof.

19. A shaped article having a metallic surface coated with an integrated pretreatment layer having a thickness of 1 to 25 μm, obtainable by a process according to claim 1.

20. The shaped article according to claim 19, wherein the metallic surface is steel, zinc or zinc alloys, aluminum or aluminum alloys.

21. The shaped article according to claim 20, wherein the integrated pretreatment layer has additionally been overcoated with one or more coating films.

22. The shaped article according to claim 21, which is an automobile body or bodywork component.

23. The shaped article according to claim 21, which is a structural element for paneling.

24. A preparation for applying an integrated pretreatment layer to a metallic surface, the preparation comprising:
(A) 20% to 70% by weight of at least one thermally and/or photochemically crosslinkable binder system (A);
(B) 20% to 70% by weight of at least one inorganic finely divided filler having an average particle size of less than 10 μm;
(C) 0.25% to 40% by weight of at least one corrosion preventative; and
(D) optionally a solvent,
with the proviso that the percentages by weight are based on the sum of all components bar the solvent, and also
wherein the corrosion preventative is at least one copolymer (C) synthesized from the following monomeric structural units:
(c1) 70 to 30 mol % of at least one monoethylenically unsaturated hydrocarbon (c1a) and/or of at least one monomer (c1b) selected from the group of monoethylenically unsaturated hydrocarbons (c1b′), modified with functional groups X¹, and vinyl ethers (c1b″);
(c2) 30 to 70 mol % of at least one monoethylenically unsaturated dicarboxylic acid having 4 to 8 C atoms and/or its anhydride (c2a) and/or derivatives (c2b) thereof, the derivatives (c2b) being esters of the dicarboxylic acid with alcohols of the general formula HO—R¹—X²ₙ (I) and/or amides or imides with ammonia and/or amines of the general formula HR²N—R¹—X²ₙ (II), and the abbreviations having the following definition:
R¹: (n+1)-valent hydrocarbon group having 1 to 40 C atoms, in which nonadjacent C atoms may also be substituted by O and/or N;
R²: H, C₁ to C₁₀ hydrocarbon group or —(R¹—X²ₙ)
n: 1, 2 or 3; and
X²: a functional group; and
(c3) 0 to 10 mol % of other ethylenically unsaturated monomers, different from (c1) and (c2) but copolymerizable with (c1) and (c2),
the amounts being based in each case on the total amount of all monomer units in the copolymer.
